(19) United States
(12) Patent Application Publication
(10) Pub. No.: US 2003/0235430 A1
(43) Pub. Date: Dec. 25, 2003

(54) Image forming apparatus

(75) Inventor: Kohei Koshida, Ibaraki-ken (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/600,704

(22) Filed: Jun. 23, 2003

(30) Foreign Application Priority Data
Jun. 24, 2002 (JP) 2002-182838

(51) Int. Cl. G03G 21/00

(52) U.S. Cl. 399/124

(57) ABSTRACT

The present invention relates to an image forming apparatus comprising an image carrier for carrying an image, an intermediate transfer body to which the image on the image carrier is transferred, transfer material conveying means for conveying a transfer material along a conveyance route, transfer means for transferring the image on the intermediate transfer body onto the transfer material conveyed by the transfer material conveying means, a delivery portion for delivering the transfer material, a first openable portion openable with respect to an apparatus body, holding the intermediate transfer body and the delivery portion and a second openable portion openable of the conveyance route. The first and second openable portions are open and closed independently from each other.

### BACKGROUND OF THE INVENTION

1. Field of the Invention

This invention relates to a layout structure for electrophotographic photocopiers, printers, recording apparatuses, and the like.

2. Description of Related Art

Multicolor image forming apparatuses using an electrophotographic method tend to require increased number of developing units and complicated processes such as, developments and transfer in overlapping the respective colors, and fixture of multiplayer toners, in comparison with conventional monochrome engines. Those apparatuses are further subject, with high frequency, to work of replacements with electrostatic latent image forming bodies such as color developers and photosensitive bodies, and a jamming recovery plan in the engine is also needed. Therefore, an engine structure excellent in maintenance and jamming recovery property is demanded.

FIG. 6 shows a perspective view showing a conventional example. A primary charger, a developing unit, and a transfer charger, not shown respectively, are disposed around each photosensitive drum, and those are made to form respective units as process cartridges 1a to 1d. Numeral 5 denotes a fixing unit; numeral 4 denotes a feeding cassette; numeral 3 denotes a secondary transfer roller; numeral 2 denotes an intermediate transfer belt (intermediate transfer body); numeral 7 denotes a delivery tray.

During maintenance work for the process cartridges 1a to 1d, a side door 10 is opened to render the process cartridges 1a to 1d able to be pulled out. As shown in FIG. 7, the intermediate transfer belt 2 is then moved in a direction of arrow X to release pressure between the intermediate transfer belt 2 and the photosensitive drums 20a to 20d of the process cartridges 1a to 1d.

The process cartridges 1a to 1d are made to slide in a direction of arrow Y as shown in FIG. 6, and new process cartridges 1a to 1d are inserted. Where a transfer material is jammed in a conveyance route 25, a front door 11 openable in a front and back direction at the conveyance route 25 as a boundary to treat jamming.

In Japanese Patent Application publication JP-A-11-133,694, to improve jamming recovery and controllability, a mechanism that the transfer portion is openable forwardly around an apparatus lower portion as a center, and a mechanism that the photosensitive body belt portion is lifted upward around an apparatus rear portion as a center, are provided, thereby allowing maintenance work and paper jamming recovery.

With the multicolor image forming apparatus as shown in FIGS. 6, 7, however, the accessing directions for replacement of the process cartridges and paper jamming recovery are on sides of apparatus front and side, so that there was a problem that working space becomes larger. It is disadvantageous that the apparatus side space is largely taken during pulling out and inserting of the process cartridges. Furthermore, the apparatus tends to be larger and more complicated due to a moving mechanism of the intermediate transfer belt for releasing pressure between the intermediate transfer belt and the photosensitive drum of the process cartridge during replacement of the process cartridge, thereby increasing the costs of the apparatus.

Because a sliding mechanism for pulling out and inserting the process cartridges is inevitably provided, the apparatus tends to be larger and more complicated. In the publication JP-A-11-133,694, where the operator conducts the maintenance work for the photosensitive bodies or the like in standing on a front side, the apparatus is structured as not to open the photosensitive belt unit upward unless the transfer unit is made open toward the front side around the apparatus lower portion as a center, and therefore, there raise problems such that not only the transfer portion opened toward the front side may become disturbed but also the operator cannot easily access to the developing unit or the like where two opening operations are needed. Moreover, as other conventional arts relating to the opening and closing operation of the apparatuses, exemplified are disclosed in Japanese Patent Application Publications JP-A-10-307,439 and JP-A-2000-6583.

### SUMMARY OF THE INVENTION

It is an object, in consideration for solving the above problems, to provide an image forming apparatus with improved controllability including jamming recovery and apparatus maintenance property and with a simplified structure of the apparatus.

A preferable image forming apparatus according to the invention to accomplish the above object includes: an image carrier for carrying an image; an intermediate transfer body to which the image on the image carrier is transferred; transfer material conveying means for conveying a transfer material along a conveyance route; transfer means for transferring the image on the intermediate transfer body onto the transfer material conveyed by the transfer material conveying means; a delivery portion for delivering the transfer material on which the image is transferred; a first openable portion openable with respect to an apparatus body, holding the intermediate transfer body and the delivery portion; and a second openable portion openable of the conveyance route, wherein the first and second openable portions are open and closed independently from each other.

### BRIEF DESCRIPTION OF THE DRAWINGS

FIG. 1 is a cross section showing an image forming apparatus;

FIG. 2 is a cross section showing a first openable portion during opened state;

FIG. 3 is a cross section showing jamming recovery operation where a second openable portion is opened;

FIG. 4 is a cross section showing process cartridge replacement operation;

FIG. 5 is an apparatus cross section illustrating another embodiment;

FIG. 6 is a perspective view showing a conventional image forming apparatus; and

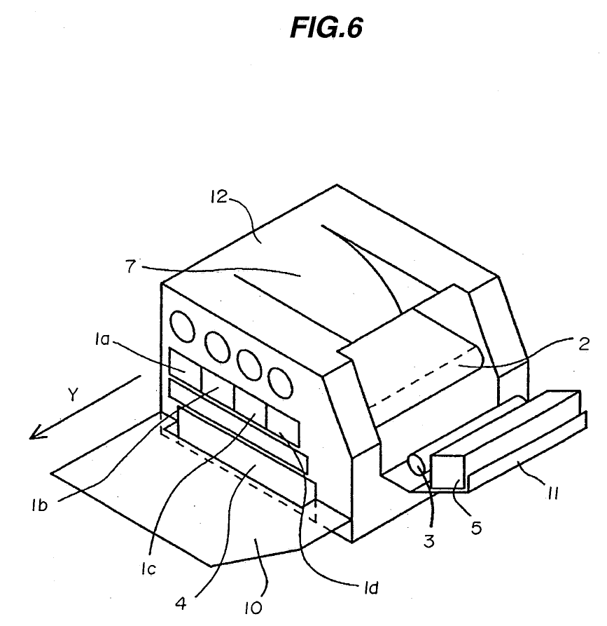

FIG. 7 is a cross section showing the conventional image forming apparatus.

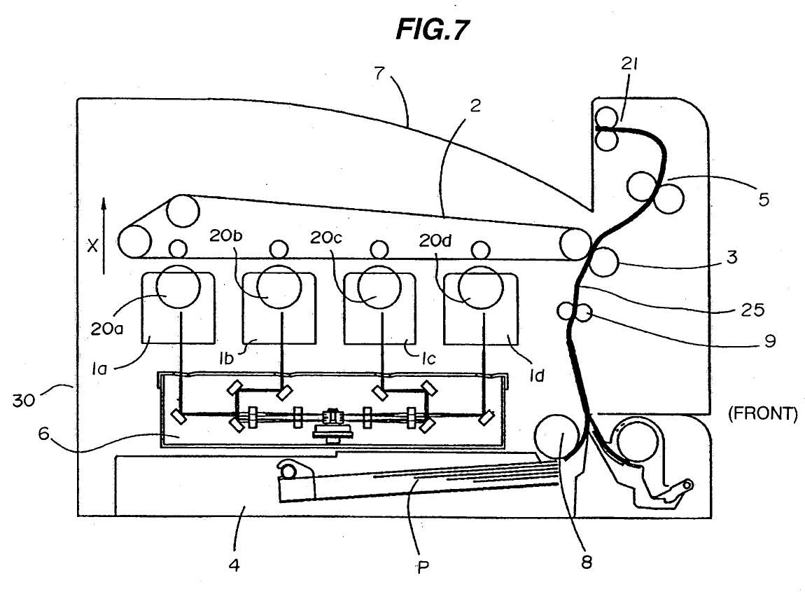

### DETAILED DESCRIPTION OF THE PREFERRED EMBODIMENTS

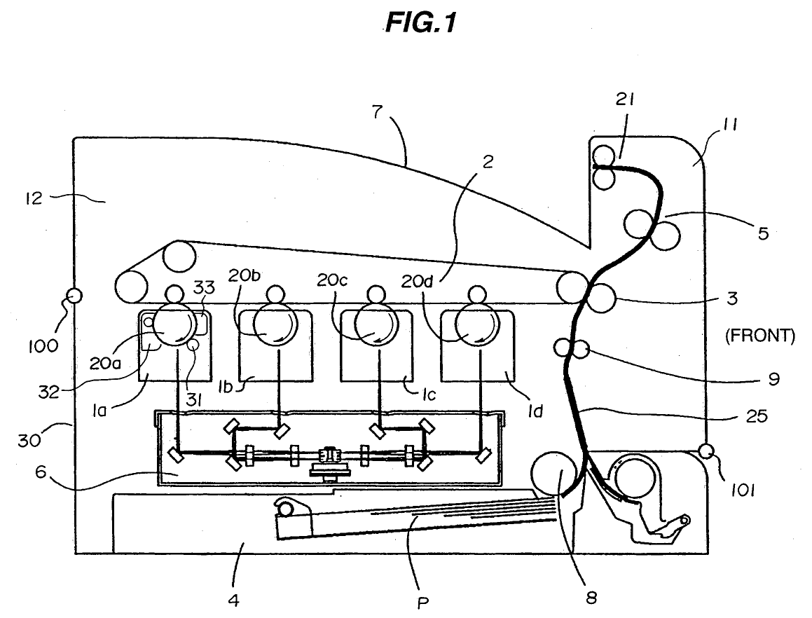

Hereinafter, embodiments in which the invention is embodied are described in referring to the drawings. First, based on FIG. 1, an image forming process is described. A printer serving as an image forming apparatus includes four photosensitive drums 20a (yellow), 20b (magenta), 20c (cyan), 20d (black) serving as image carriers disposed parallel for forming toner images in respective colors of yellow, magenta, cyan, and black, and an intermediate transfer belt 2 disposed above those photosensitive drums 20a to 20d in a manner across those drums downwardly. The photosensitive drums and the intermediate transfer belt rotate in a direction of arrow shown in FIG. 1.

A charger 31, a developer 32, and a cleaner 33 are disposed around the photosensitive drum 20a, and those are made united as a process cartridge (image forming unit) 1a. Other photosensitive drums 20b to 20d also have substantially the same structure as the photosensitive drum 20a and form the process cartridges 1b to 1d, respectively. The photosensitive drums 20a to 20d are charged by the respective chargers, and latent images for yellow, magenta, cyan, and black are formed on the photosensitive drums 20a to 20d upon exposure of color-resolved photo images in respective colors, yellow, magenta, cyan, and black with an exposing apparatus 6. The respective latent images are developed with the developers to form toner images in yellow, magenta, cyan, and black on the photosensitive drums 20a to 20d, thereby being transferred onto the intermediate transfer belt 2 sequentially.

A transfer material P is contained in a feeding cassette 4. The feeding cassette 4 has a structure that can be pulled out in a front side, and for example, supply of the transfer material P and recovery of paper jamming when jammed can be done by pulling the feeding cassette 4 on a front side of the apparatus. The transfer material P is fed out one by one with a pickup roller (feeding conveying means) 8 from the feeding cassette 4, and is conveyed to a nipping portion constituted of a secondary transfer roller 3 and the intermediate transfer belt 2 after matching the timing by means of the register roller 9, thereby to secondarily transfer the toner image on the intermediate transfer belt 2.

The transfer material P on which the toner images are secondarily transferred is then conveyed to a fixing unit 5, and fixing is made upon reception of heat and pressure thereat. Fixing melts the toners in respective colors and brings mixed colors to form a full color printed image immobilized on the transfer material P, and then, the transfer material P is delivered on a delivery tray 7 by a delivery conveying means 21 disposed on a downstream side of a fixing unit 5.

Next, an apparatus structure is described. In the color image forming apparatus shown in FIG. 1, the feeding cassette 4 is disposed on the lowest portion of the body 30. The process cartridges 1a to 1d for performing image formation are arranged sequentially below the intermediate transfer belt 2 at the apparatus body 30, and the exposing apparatus 6 is disposed below the process cartridges 1a to 1d.

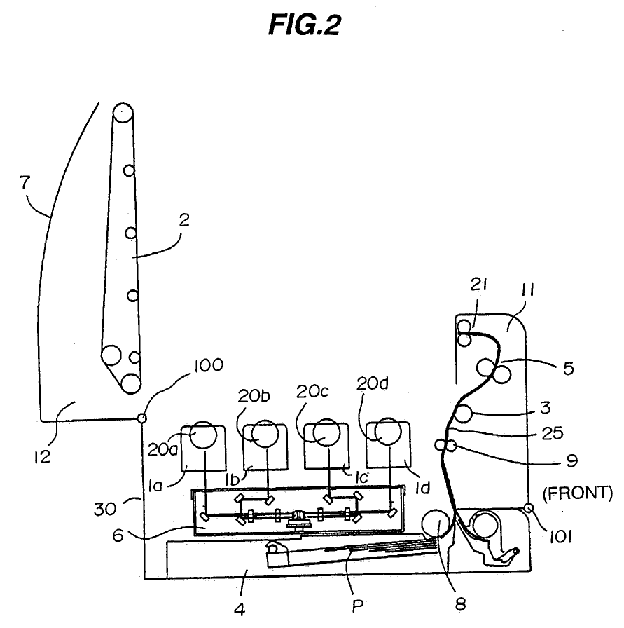

A delivery tray 7 is disposed above the intermediate transfer belt 2. The intermediate transfer belt 2 and the delivery tray 7 are made into a unit at the same housing (top opening mechanism, first openable portion) 12, and are openable around a shaft 100 as a center with respect to the apparatus body 30 as shown in FIG. 2. The fixing unit 5 is disposed above the secondary transfer roller 3 at a location not interfering with the housing 12 during opening and closing. A conveyance route 25 of the transfer material is arranged on a front side of the apparatus body, and a route from the feeding cassette 4 located at the lowest position to the delivery tray 7. The front door (front opening mechanism, second openable portion) 11 has a center 101 below the apparatus front side to allow accessing to the conveyance route 25, and is openable at the conveyance route 25 as a boundary. At that time, the secondary transfer roller 3 is opened as supported to the front door 11.

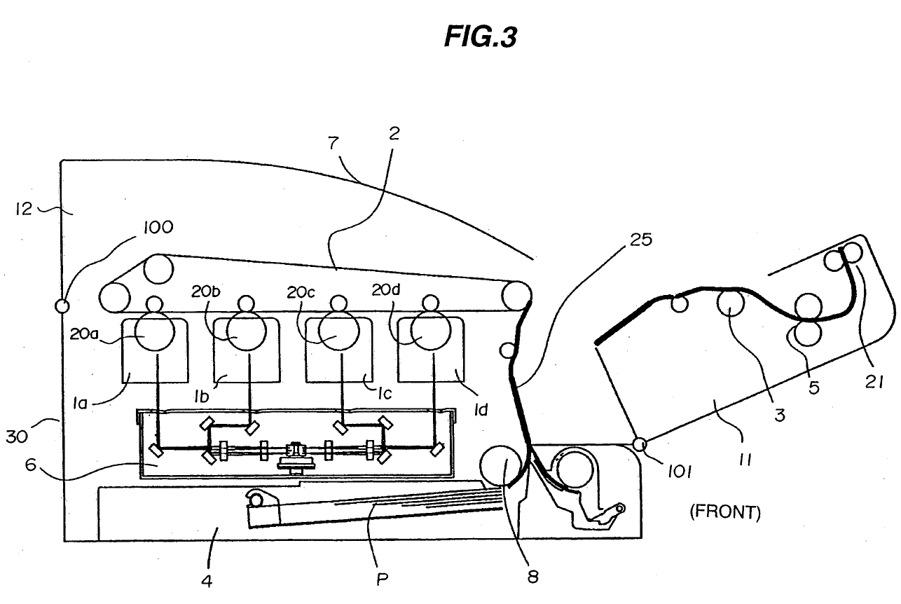

Subsequently, manipulations during process cartridge replacement and paper jamming recovery, are described. FIG. 3 is a cross section during jamming recovery operation. In a case that jamming occurs during the operation of the image forming apparatus, the pressure of the spring or the like pushing the secondary transfer roller 3 to the intermediate transfer belt 2 is released, and then, the front door 11 is opened with respect to the shaft 101 as a center located at a lower portion as shown in FIG. 3. After the front door 11 openable forward and backward with respect to the conveyance route 25 is thus moved on a front side of the apparatus body 30, paper jamming recovery is performed at the conveyance route 25.

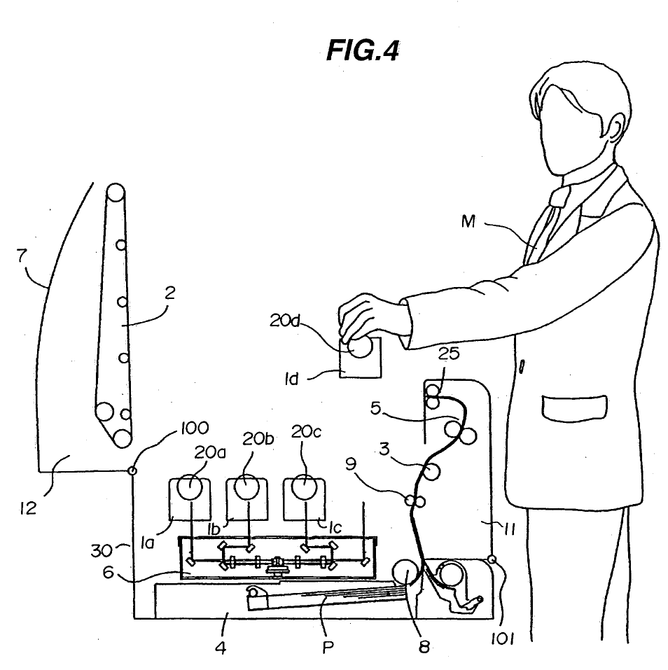

FIG. 4 is a cross section during process cartridge replacement operation. When the process cartridges 1a to 1d are replaced as maintenance work, an operator M renders open upward the housing 12 structured of the delivery tray 7 and the transfer belt 2. For example, when the process cartridge 1d for black is replaced, after the process cartridge 1d is pulled out upwardly, and a new one is attached. At that time, the front door 11 opened during the jamming recovery is not necessarily opened, so that the process cartridge 1 can be accessed easily. The process cartridge 1 can be inserted along the guide from an upper portion when attached, so that no space is needed for forming a sliding mechanism for pulling out and inserting the process cartridge from a side surface of the apparatus body, and so that with a simpler structure, the apparatus can be made in a not large size and the costs can be reduced.

Other Embodiments

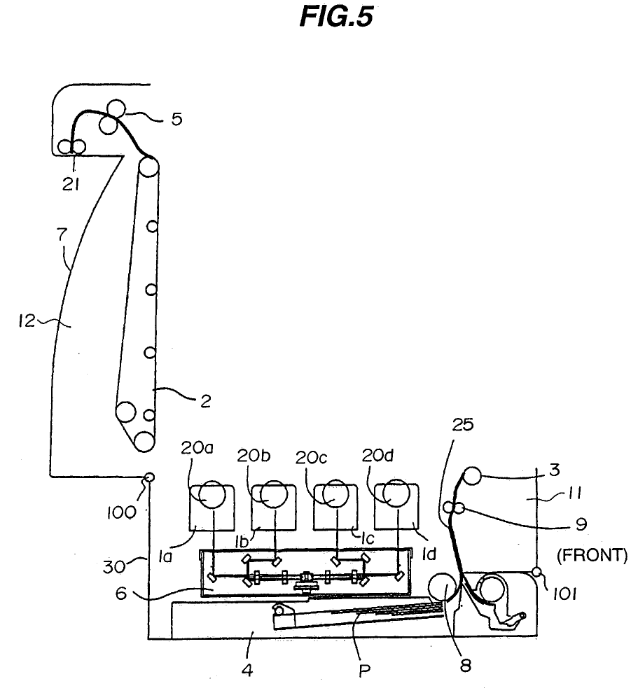

Although in the above embodiment the housing 12 is made open and closed with respect to the conveyance route 25 as a boundary and around the shaft 100 as a center to replace the process cartridges, the invention is not limited to this, and as shown in FIG. 5, the housing 12 can be structured to be openable in securing not only the intermediate transfer belt 2 and the delivery tray 7 but also the fixing unit 5.

Although in the above embodiment, the image forming apparatus is made of a printer, the invention is not limited to this, and is applicable to a facsimile machine and a photocopier.

What is claimed is:

1. An image forming apparatus comprising:
an image carrier for carrying an image;
an intermediate transfer body to which the image on the image carrier is transferred;
transfer material conveying means for conveying a transfer material along a conveyance route;
transfer means for transferring the image on the intermediate transfer body onto the transfer material conveyed by the transfer material conveying means;
a delivery portion for delivering the transfer material on which the image is transferred;
a first openable portion openable with respect to an apparatus body, holding the intermediate transfer body and the delivery portion; and
a second openable portion openable of the conveyance route,
wherein the first and second openable portions are open and closed independently from each other.

2. The image forming apparatus according to claim 1, wherein the first openable portion is openable around a first rotary shaft as a center, wherein the second openable portion is openable around a second rotary shaft as a center, and wherein the first rotary shaft and the second rotary shaft are disposed as to extend substantially parallel to a transfer material conveyance surface and substantially perpendicular to a conveyance direction of the transfer material.

3. The image forming apparatus according to claim 2, wherein the first rotary shaft and the second rotary shaft are disposed at positions that the first openable portion and the second openable portion are opened as moving away from each other.

4. The image forming apparatus according to claim 1, wherein the intermediate transfer body, the delivery portion, and the first openable portion are structured in a united body.

5. The image forming apparatus according to claim 1, further comprising a holding unit for holding the image carrier, the holding unit being detachable to the apparatus body upon opening the first openable portion.

6. The image forming apparatus according to claim 1, wherein the holding unit is detachable in a vertical direction as of an apparatus installation time.

7. The image forming apparatus according to claim 1, wherein the transfer means has a transfer member in contact with the intermediate transfer body, and wherein the transfer member is held to the second openable portion.

8. The image forming apparatus according to claim 1, wherein the transfer material conveying means has at least a pair of roller members, wherein one roller member is held to the apparatus body, and wherein the other roller member is held to the second openable portion.

9. The image forming apparatus according to claim 1, further comprising a fixing means held to the second openable portion for fixing the image transferred from the intermediate transfer body to the transfer material.

10. The image forming apparatus according to claim 1, further comprising a fixing means held to the first openable portion for fixing the image transferred from the intermediate transfer body to the transfer material.
